(19) United States
(12) Patent Application Publication
(10) Pub. No.: US 2012/0174772 A1
(43) Pub. Date: Jul. 12, 2012

(54) APPARATUS AND METHOD FOR MIXING AND EXCHANGING FLUIDS

(75) Inventor: Alex Knobel, Curitiba (BR)

(73) Assignee: FRANZ HAAS WAFFEL- UND KEKSANLAGEN-INDUSTRIE GMBH, LEOBENDORF (AT)

(21) Appl. No.: 13/388,197

(22) PCT Filed: Aug. 2, 2010
(86) PCT No.: PCT/IB10/01904

§ 371 Date: Mar. 6, 2012

(30) Foreign Application Priority Data
Jul. 31, 2009 (CH) 1383/09

(51) Int. Cl. B01D 69/12; B01D 19/00; B01F 3/04

(52) U.S. Cl. 95/46; 96/11; 95/45

(57) ABSTRACT

In a device and a method for mixing and exchanging fluids, a first chamber is a mixing chamber with static mixing elements. First and second fluids flow through the first chamber in a mixing fluid flow direction. A second chamber adjacent the first chamber is a fluid feeding or discharge chamber through which the second fluid flows. A semipermeable membrane separates the volume of the first chamber from the volume of the second chamber. The membrane is impermeable to molecules or molecule agglomerations of the first fluid and permeable to molecules or molecule agglomerations of the second fluid. The membrane is made of a material or is coated with a material to which the molecules or molecule agglomerations of one of the two fluids have a lower affinity. Alternatively, or in addition, the membrane is elastic and spans a support wall with holes.

The invention relates to an apparatus and to a method for mixing and exchanging fluids, in particular for introducing gas into liquids or removing it therefrom.

A large number of apparatuses are known for introducing gas into liquids or removing it therefrom. These apparatuses usually operate with large boundary surfaces between the liquid and gaseous phases, in order for it to be possible for large quantities of gas to be transported into the liquid, or out of the same, in as short a time as possible.

It is also known to have apparatuses for introducing gas into liquids or removing it therefrom, and for filtering liquids, in which a membrane is arranged between a gaseous phase and a liquid phase, this membrane being permeable to the gas and impermeable to the liquid.

Such an apparatus is disclosed, for example, in the document EP 0 226 788 B1. This apparatus contains a semi-permeable membrane in a wall between a gas stream and a liquid stream. In particular, reference is also made to a semi-permeable membrane for introducing gas into the liquid without bubbles, for which purpose the semi-permeable membrane is permeable to a gaseous medium which is to be added. This gives rise, however, to the problem where the gas penetrating into the liquid through the semi-permeable membrane is transported away only very ineffectively by the liquid, since a boundary layer in the liquid forms on the membrane surface. This boundary layer is, in practical terms, stationary on the membrane surface. The wetting and soaking of the membrane or the membrane pores by the liquid encourages the formation of such a stationary boundary layer.

It is an object of the invention to improve the exchange of substances at a semi-permeable membrane between a first fluid and a second fluid.

This object is achieved by the invention, according to a first aspect, by an apparatus for mixing and exchanging fluids, having a first chamber and a second chamber, adjacent to the first chamber, wherein the first chamber is a mixing chamber with static mixing elements, through which at least a first fluid and a second fluid can flow in a mixing-fluid-flow direction, and the second chamber is a fluid-supply chamber or fluid-discharge chamber, through which the second fluid can flow, wherein a semi-permeable membrane is arranged at least in parts of the boundary region between the volume of the first chamber and the volume of the second chamber, this membrane being impermeable to molecules or molecule agglomerations of the first fluid and being permeable to molecules or molecule agglomerations of the second fluid, characterized in that the membrane consists of a material, or is coated with a material, for which at least the molecules or molecule agglomerations of one of the two fluids have a low affinity.

The first aspect makes it difficult for one of the two fluids to form a stationary boundary layer at the membrane.

This object is achieved by the invention, according to a second aspect, by an apparatus for mixing and exchanging fluids, having a first chamber and a second chamber, adjacent to the first chamber, wherein the first chamber is a mixing chamber with static mixing elements, through which at least a first fluid and a second fluid can flow in a mixing-fluid-flow direction, and the second chamber is a fluid-supply chamber or fluid-discharge chamber, through which the second fluid can flow, wherein a semi-permeable membrane is arranged at least in parts of the boundary region between the volume of the first chamber and the volume of the second chamber, this membrane being impermeable to molecules or molecule agglomerations of the first fluid and being permeable to molecules or molecule agglomerations of the second fluid, characterized in that the semi-permeable membrane is an elastic membrane which is mounted on a supporting wall provided with a multiplicity of holes.

The second aspect likewise makes it difficult for one of the two fluids to form a stationary boundary layer at the membrane, in that subjecting one of the two fluids to pulsating pressure gives rise to a pressure difference with fluctuations in pulsating fashion being generated between the two sides of the membrane.

Preferably the measures according to the first aspect and the second aspect are combined, i.e. the membrane consists of a material, or is coated by a material, for which at least the molecules or molecule agglomerations of one of the two fluids have a low affinity, and the semi-permeable membrane is an elastic membrane which is mounted on a supporting wall provided with a multiplicity of holes.

The semi-permeable membrane may be a hydrophobic (water-repelling) membrane. In this case, the wetting or soaking of the membrane is made difficult by a polar liquid, e.g. water.

The semi-permeable membrane may also be an oleophobic (oil-repelling) membrane. In this case, the wetting or soaking of the membrane is made difficult by a non-polar liquid, e.g. oil.

The semi-permeable membrane is preferably an oleophobic and hydrophobic (oil-repelling and water-repelling) membrane. In this case, the wetting or soaking of the membrane is made difficult by a non-polar liquid, e.g. oil, and by water.

The gas-permeable membrane of the apparatus according to the invention is preferably a polymer membrane which is permeable to gas molecules such as O₂, N₂ and CO₂ and is applied preferably to a porous carrier material and connected thereto. The effective pore size of the gas-permeable membrane here is preferably in the range of 0.1 nm to 10 nm, whereas the carrier material may have a much larger effective pore size.

The material used for the gas-permeable membrane is preferably one of the following polymers: cellulose acetate (CA), cellulose nitrate (CN), cellulose esters (CE), polysulfone (PS), polyethersulfone (PES), polyacrylonitrile (PAN), polyamide (PA), polyimide (PI), polyethylene (PE), polypropylene (PP), polytetrafluoroethylene (PTFE), polyvinylidene fluoride (PVDF) polyvinyl chloride (PVC) and polyurethane (PU).

The thickness of the gas-permeable membrane is approximately 1 μm to 300 μm, preferably 10 μm to 200 μm.

The carrier material for stabilizing the gas-permeable membrane may be a nonwoven material, a textile material, e.g. made of polyester, or some other porous material, of which the effective pore size is greater by a multiple than the effective pore size of the gas-permeable membrane.

The supporting wall may have circular holes and/or slot-like holes. As a result of the hole diameters or slot widths, on the one hand, and of the tensioning of the mounted elastic semi-permeable membrane, fluttering of the membrane portions tensioned over the hole openings can be achieved by the aforementioned pulsation. This makes it possible to increase the throughput of substances at the membrane and to free the membrane of deposits thereon. For this purpose, the low-frequency pulsation can be assisted by high-frequency vibrations (ultrasound).

Expediently, the first chamber within the apparatus bounds a continuous (interlinked) mixing-chamber volume, and the second chamber within the apparatus is formed by sub-chambers which are separate (from one another) and have a respective sub-volume of the fluid-supply chamber or fluid-discharge chamber, wherein the sub-chambers upstream of the apparatus open out into a fluid-supply collecting line and those downstream of the apparatus open out into a fluid-discharge collecting line.

The sub-chambers of the second chamber are preferably transverse channels which extend transversely to the mixing-fluid-flow direction of the first chamber and of which the channel walls have a supporting wall, provided with a multiplicity of holes, and an elastic membrane, mounted on the supporting wall, as a semi-permeable membrane. These transverse channels are both obstacles/chicanes in the static mixing chamber and distributors for the second fluid, for the supply (e.g. introduction of gas) thereof or the discharge (e.g. discharge of gas) thereof.

Spaced-apart transverse channels with a circular or with a polygonal channel cross section are preferably provided, wherein the transverse channels preferably run parallel to one another.

In order to optimize the packing density with transverse channels, it is preferable to provide a first multiplicity of transverse channels with a first channel cross-sectional surface area and a second multiplicity of transverse channels with a second channel cross-sectional surface area, wherein preferably the transverse channels of the first multiplicity of transverse channels and of the second multiplicity of transverse channels are distributed uniformly in the first chamber. Use is advantageously made here of a ratio between a second channel cross-sectional surface area and a first channel cross-sectional surface area in the range of 1/10 to 5/10.

In the case of a particularly advantageous embodiment, a pressure source which can generate a variable pressure is in fluid connection with the first chamber or with the second chamber. This pressure source makes pulsation possible, which, in the region of the holes covered by the tensioned elastic membrane, results in “fluttering” of the elastic membrane, and this assists the through-passage of the second fluid through the membrane in order to be supplied into the first fluid (e.g. introduction of gas) or in order to be discharged from the first fluid (e.g. removal of gas).

It is expedient for the transverse channels, in the region of their respective first end, to be fastened on a first carrier (e.g. first wall panel) and to extend through the same, wherein the first carrier and the transverse channels together form a first subassembly of the apparatus. It is further expedient if the transverse channels of the first subassembly, in the region of their respective second end, extend through openings in a second carrier (e.g. second wall panel), wherein the second carrier together with further walls of the first chamber form a second subassembly of the apparatus. This allows the apparatus to be quickly dismantled and assembled for maintenance purposes (cleaning, membrane changeover).

The transverse channels preferably form the static mixing elements of the first chamber, i.e. the apparatus is a static mixer, of which the deflecting elements are hollow and communicate (partially) with the mixing chamber via the (semi-permeable) membrane according to the invention.

The invention also provides a method for mixing and exchanging fluids using the abovedescribed apparatus, wherein a first fluid and a second fluid are fed through the first chamber (mixing chamber) and the second fluid is fed through the second chamber.

The method can be used for introducing gas into a liquid, wherein a liquid/gas mixture is directed through the first chamber and the gas, with a pressure greater than the pressure of the liquid/gas mixture in the first chamber, is directed through the second chamber.

The method can also be used for removing gas from a liquid, wherein a liquid/gas mixture is directed through the first chamber and the gas, with a pressure smaller than the pressure of the liquid/gas mixture in the first chamber is directed through the second chamber.

During the introduction or removal of gas, the pressure in the first chamber or the pressure in the second chamber is preferably subjected to pulsation. This gives essentially two types of operation, by which the elastic semi-permeable membrane mounted on the hole-containing supporting wall is deflected by pulses or made to flutter.

According to a first gas-introduction variant, the membrane is deflected perpendicularly to the supporting wall only in the region of the holes of the supporting wall. This type of “local” fluttering/vibration of the membrane is assisted by high membrane tensioning and high viscosity of the liquid, which completely fills the first chamber.

According to a second gas-introduction variant, the membrane is deflected perpendicularly to the supporting wall over that entire region of the supporting wall which is provided with holes. This type of “global” fluttering/vibration of the membrane is assisted by low membrane tensioning, low viscosity of the liquid and if the first chamber is only partially filled.

The pulse-like membrane movements perpendicular to the hole-containing supporting surfaces does not just assist the introduction of gas into the liquid, or removal of gas therefrom, in the first chamber; in addition, pulses are also transmitted to the liquid flowing in the first chamber. The second gas-channeling chamber may also be subdivided, and therefore a first fraction of the sub-chambers or the transverse channels communicate with one another and another fraction of the sub-chambers or transverse channels, this other fraction being separated hermetically from the first fraction, communicate with one another. The second chamber may be subdivided into a plurality of such parts. The respective parts of the second chamber can then be subjected to pulsation at staggered intervals, this making it possible to influence the flow behavior of the liquid in the first chamber.

It is particularly advantageous for the method to make use of an apparatus with a hydrophobic membrane, wherein the liquid has substances which are dissolved in water, emulsified in water or suspended in water. This makes it possible, for example, for aqueous candy compounds, which have sugar molecules dissolved in water, to be subjected to micro-scale aeration. Particular reference should be made here to the micro-scale aeration of sugar icing.

It is particularly advantageous for the method also to make use of an apparatus with an oleophobic membrane, wherein the liquid has substances which are dissolved in fat or oil, emulsified in fat or oil or suspended in fat or oil. This makes it possible, for example, for fat-based/oil-based candy compounds, which contain sugar particles suspended in fat or oil and, for example, cocoa particles, to be subjected to micro-scale aeration and deaeration. Particular reference should be made here to the micro-scale aeration or deaeration of chocolate.

Further advantages, features and possible applications of the invention can be gathered from the description which now follows of an exemplary embodiment, which is not to be understood as limiting, with reference to the drawing, wherein

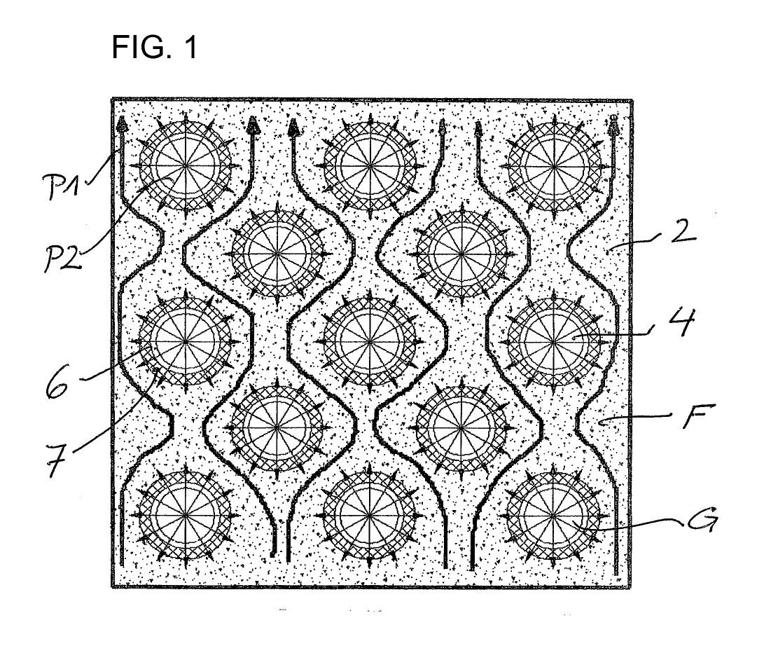

FIG. 1 shows a first exemplary embodiment of the apparatus according to the invention in the form of a sectional drawing of part of the apparatus;

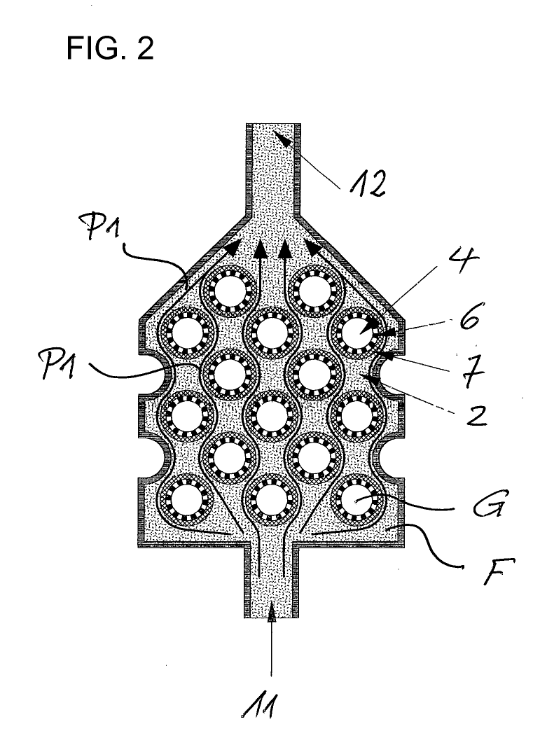

FIG. 2 shows the first exemplary embodiment of the apparatus according to the invention in the form of a sectional drawing of the apparatus; and

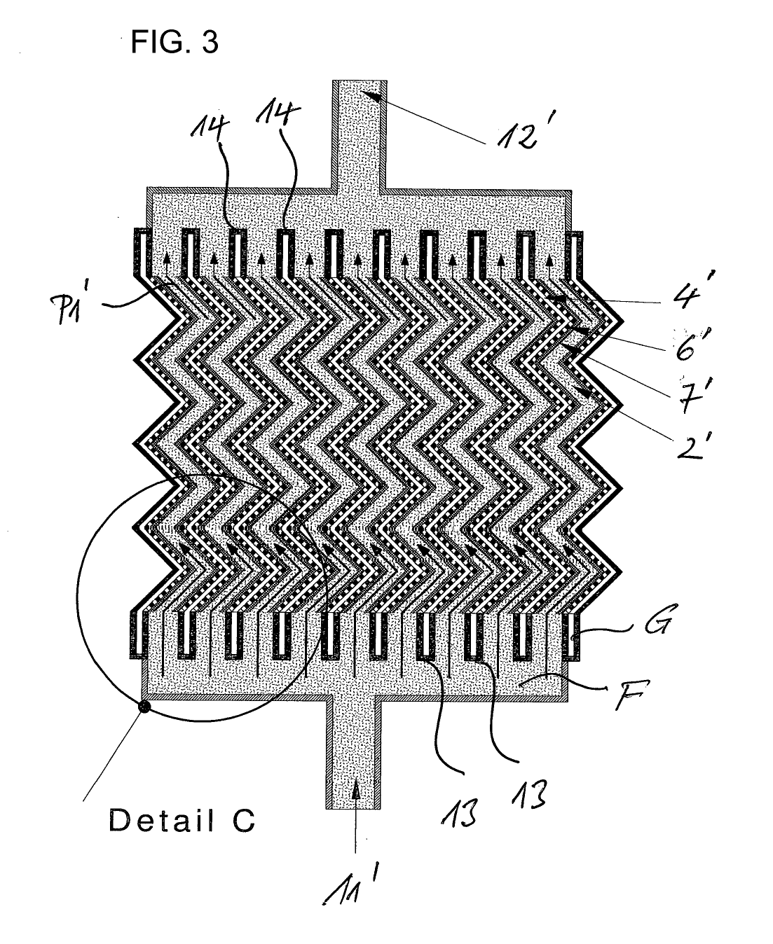

FIG. 3 shows a second exemplary embodiment of the apparatus according to the invention in the form of a sectional drawing of the apparatus; and

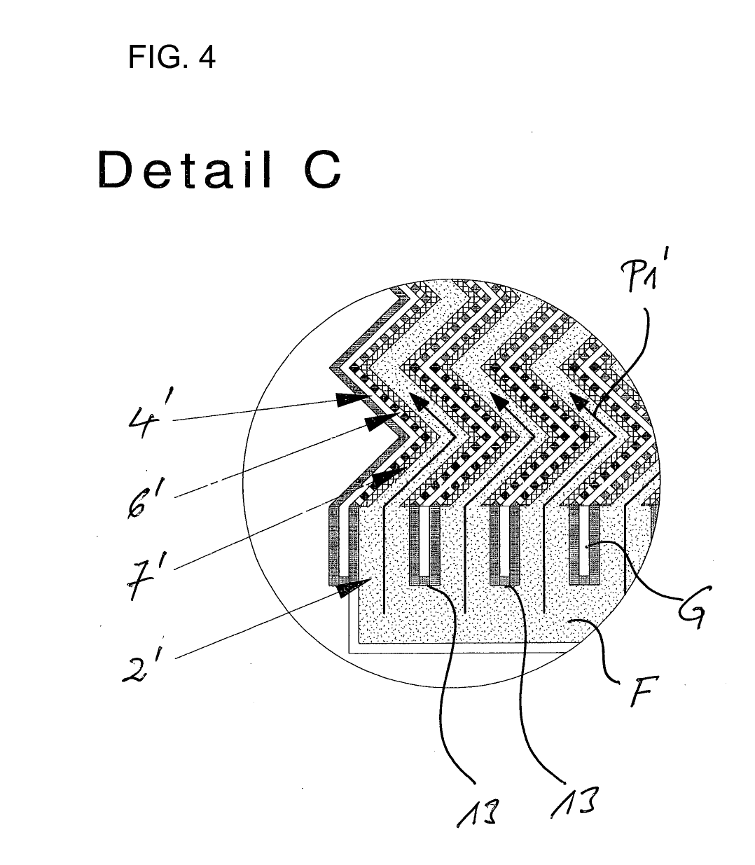

FIG. 4 shows an enlarged illustration of detail C from FIG. 3.

FIG. 1 shows a first exemplary embodiment of the apparatus according to the invention in the form of a sectional drawing of part of the apparatus. FIG. 1 shows a detail of the apparatus for mixing and exchanging fluids, in particular for introducing a gas G into a liquid F or removing a gas G from a liquid F. The section plane (drawing plane) runs parallel to the predominant or prevailing flow direction of the liquid F in a first chamber 2. This flow direction is indicated by the thick meandering lines designated by arrows P1. Only a detail of the apparatus is shown. Sub-chambers or transverse channels 4, which are bounded by tubular walls 6 with holes (not shown), extend transversely through the first chamber 2. An elastic membrane 7 is tensioned over the hole-containing tubular walls 6, this membrane being permeable to the gas G and impermeable to the liquid F. The flow direction of the gas G for the case of gas being introduced into the liquid F is indicated by the respective twelve arrows P2 on each hole-containing tube 6. The apparatus shown here can also be used for the removal of gas. For the case of gas being removed, the direction of the arrows P2 would be the opposite.

In practice, it is also possible for further sub-chambers or transverse channels 2 to be arranged along the flow direction P1, upstream and downstream of the detail illustrated, and transversely to the flow direction P1, to the left and right of the detail illustrated.

The housing of the first chamber 2 and the tubes of the transverse channels 4 may consist of metal, in particular of stainless steel or anodized aluminum, or of a polymer, in particular of polyester, e.g. polyethylene terephthalate, or of polycarbonate.

The gas-permeable membrane (not illustrated separately) is a polymer membrane which is permeable to gas molecules such as O₂, N₂ and CO₂ and is applied to a porous carrier material (not illustrated separately) and connected thereto. Its effective pore size is in the range of 0.1 nm to 10 nm, whereas the carrier material has a much larger effective pore size. The size of the “pores” of the carrier material is expediently a multiple of the effective pore size of the membrane and is preferably in the range of 0.1 μm to 10 μm. This ensures that large molecules, e.g. fat molecules or sugar molecules of food substances, or water molecules, which tend to agglomerate (form clusters), cannot pass through the membrane, whereas the small, non-agglomerated gas molecules can easily pass through the membrane 7.

The material used for the gas-permeable membrane may be one of the following polymers: cellulose acetate (CA), cellulose nitrate (CN), cellulose esters (CE), polysulfone (PS), polyethersulfone (PES), polyacrylonitrile (PAN), polyamide (PA), polyimide (PI), polyethylene (PE), polypropylene (PP), polytetrafluoroethylene (PTFE), polyvinylidene fluoride (PVDF) polyvinyl chloride (PVC) and polyurethane (PU). Particularly preferred gas-permeable membrane materials are PS (repelling surface) and PU (high level of extensibility). The thickness of the gas-permeable membrane is approximately 100 μm.

The carrier material used for stabilizing the gas-permeable membrane may be a nonwoven material, a textile material, e.g. made of polyester, or some other porous, but elastically extensible material, of which the effective pore size is much greater than the effective pore size of the only gas-permeable membrane.

The elastic membrane 7 is a tubular structure and can be pulled onto the tubular walls 6 of the transverse channels 4 in an extended state.

The essential operating parameters for introducing gas G into the liquid F and removing gas G from the liquid F are as follows: effective pore size of the membrane 7, pressure difference between the liquid-channeling first chamber 2 and the gas-channeling second chamber 4, flow speed of the liquid F, temperature/viscosity of the liquid F, cross-sectional shape of the transverse channels 4 (e.g. circular, lenticular, polygonal, in particular triangular or hexagonal), pressure-difference amplitude and frequency of the pulsation of the gas G and/or of the liquid F.

Operating temperatures of approximately 10° C. to approximately 100° C. arise in the introduction of gas into liquids, or the removal of gas from liquids, which have particles which are dissolved in water, emulsified in water or suspended in water or have particles which are dissolved in fat or oil, emulsified in fat or oil or suspended in fat or oil. The aforementioned polymer materials are stable at these temperatures and are thus suitable for introducing gas into such liquids and/or removing gas therefrom.

FIG. 2 shows the first exemplary embodiment of the apparatus according to the invention in the form of a sectional drawing of the apparatus. FIG. 2 shows the apparatus for mixing and exchanging fluids, in particular for introducing a gas G into the liquid F, or for removing a gas G from the liquid F, in a section which runs parallel to the prevailing flow direction of the liquid F. The section plane (drawing plane) runs parallel to the predominant or prevailing flow direction of the liquid F in the first chamber 2.

At the upstream end, the apparatus has an inlet 11, which opens out into the first chamber 2. At the downstream end, the apparatus has an outlet 12, which opens out of the first chamber 2. This flow direction is indicated by the thick meandering lines designated by arrows P1. The sub-chambers or transverse channels 4, which are bounded by the tubular walls 6, extend transversely through the first chamber 2 and transversely to the flow direction of the liquid F. These walls are illustrated schematically with alternately light and dark regions, wherein the light regions represent the relatively large holes of the wall, which is illustrated by a dark color. The elastic membrane 7, which is permeable to the gas G and impermeable to the liquid F, is tensioned over the hole-containing tubular walls 6. The gas G flowing in the interior of the transverse channels 4 passes through the wall 6, and the membrane 7 tensioned over the same, and thus passes into the liquid F flowing in the chamber 2.

FIG. 3 shows a second exemplary embodiment of the apparatus according to the invention in the form of a sectional drawing of the apparatus. FIG. 3 shows the apparatus for mixing and exchanging fluids, in particular for introducing a gas G into the liquid F, or for removing a gas G from the liquid F, in a section which runs parallel to the prevailing flow direction of the liquid F. The elements of FIG. 3 which correspond, or are identical, to the elements from FIG. 2 have the same designations as in FIG. 2, but are provided with a prime stroke. The section plane (drawing plane) runs parallel to the predominant or prevailing flow direction of the liquid F in the first chamber 2′.

At the upstream end, the apparatus has an inlet 11′, which opens out into the first chamber 2′. At the downstream end, the apparatus has an outlet 12′, which opens out of the first chamber 2′. At the upstream end, the apparatus has a first distributor 13, which opens out in transverse chambers or secondary chambers 4′. At the downstream end, the apparatus has a second distributor 14, which opens out of the transverse chambers 4′. The flow direction of the liquid F is indicated by the arrows P1′. Sub-chambers or transverse channels 4′, which are bounded by zigzag walls 6′, extend transversely through the first chamber 2′ and transversely to the flow direction of the liquid F. These walls are illustrated schematically by alternately light and dark regions, wherein the light regions represent the relatively large holes of the wall, which is illustrated by a dark color. An elastic membrane 7′, which is permeable to the gas G and impermeable to the liquid F, is tensioned over the hole-containing zigzag walls 6′ or fastened at separate points of the walls 6′. The gas G flowing in the interior of the transverse channels 4′ passes through the wall 6′, and the membrane 7′ arranged over the same, and thus passes into the liquid F flowing in the chamber 2′. Both the chamber 2′, in which the liquid flows, and the transverse chambers 4′, in which the gas G flows, have a zigzag geometry.

The second exemplary embodiment, which is shown in FIG. 3, makes it possible, for a given flow direction of the liquid F in the first chamber 2′, for the gas G to be introduced into the liquid in the same or opposite direction. Of course, transverse gas introduction is also possible here, as in the case of the first exemplary embodiment, if the first distributor 13 and the second distributor 14 are arranged to the left and right of the chamber 2′ (i.e. above and beneath the section/drawing plane in FIG. 3).

FIG. 4 shows an enlarged illustration of detail C from FIG. 3. The distributor 13, which communicates with the secondary chambers 4′ is evident here in particular.

1-24. (canceled)

25. An apparatus for mixing and exchanging fluids, the apparatus comprising:
a first chamber having static mixing element disposed therein, said first chamber forming a mixing chamber through which at least a first fluid and a second fluid can flow in a mixing-fluid-flow direction;
a second chamber adjacent said first chamber, said second chamber forming a fluid-supply chamber or a fluid-discharge chamber through which the second fluid can flow;
a semi-permeable membrane disposed at least in parts of a boundary region between a volume of said first chamber and a volume of said second chamber, said membrane consisting of, or being coated with, a material to which molecules or molecule agglomerations of one of the first or second fluids have a low affinity, and wherein said membrane is impermeable to molecules or molecule agglomerations of the first fluid and permeable to molecules or molecule agglomerations of the second fluid.

26. The apparatus according to claim 25, wherein said semi-permeable membrane is an elastic membrane mounted on a supporting wall formed with a multiplicity of holes.

27. The apparatus according to claim 26, wherein said supporting wall is formed with holes selected from the group consisting of circular holes and slit-shaped holes.

28. The apparatus according to claim 25, wherein said semi-permeable membrane is a hydrophobic membrane.

29. The apparatus according to claim 25, wherein said semi-permeable membrane is an oleophobic membrane.

30. The apparatus according to claim 25, wherein said first chamber bounds a contiguous and interlinked mixing-chamber volume, said second chamber is formed by a plurality of mutually separate sub-chambers each having a respective sub-volume of the fluid-supply chamber or fluid-discharge chamber, wherein said sub-chambers upstream of the apparatus open out into a fluid-supply collecting line and said sub-chambers downstream of the apparatus open out into a fluid-discharge collecting line.

31. The apparatus according to claim 30, wherein said sub-chambers of said second chamber are transverse channels extending transversely to the mixing-fluid-flow direction of said first chamber and channel walls of said sub-chambers have a supporting wall, formed with a multiplicity of holes, and a semi-permeable, elastic membrane mounted on said supporting wall.

32. The apparatus according to claim 31, wherein said transverse channels are spaced-apart transverse channels with a circular or polygonal channel cross section.

33. The apparatus according to claim 32, wherein said transverse channels extend parallel to one another.

34. The apparatus according to claim 32, wherein said transverse channels include a first multiplicity of transverse channels with a first channel cross-sectional surface area and a second multiplicity of transverse channels with a second channel cross-sectional surface area.

35. The apparatus according to claim 34, wherein said transverse channels of said first multiplicity of transverse channels and of said second multiplicity of transverse channels are distributed uniformly in said first chamber.

36. The apparatus according to claim 34, wherein a ratio between a second channel cross-sectional surface area to a first channel cross-sectional surface area lies in the range from 1:10 to 5:10.

37. The apparatus according to claim 25, which further comprises a pressure source for generating a variable pressure in fluidic communication with said first chamber or with said second chamber.

38. The apparatus according to claim 31, wherein said transverse channels, in a region of their respective first ends, are fastened on a first carrier (e.g. first wall panel) and extend therethrough, and wherein said first carrier and said transverse channels together form a first subassembly of the apparatus.

39. The apparatus according to claim 38, wherein said transverse channels of the first subassembly, in a region of their respective second ends, extend through openings in a second carrier (e.g. second wall panel), and wherein said second carrier together with further walls of said first chamber form a second subassembly of the apparatus.

40. The apparatus according to claim 31, wherein said transverse channels form said static mixing elements of said first chamber.

41. An apparatus for mixing and exchanging fluids, the apparatus comprising:
a first chamber having static mixing element disposed therein, said first chamber forming a mixing chamber through which at least a first fluid and a second fluid can flow in a mixing-fluid-flow direction;
a second chamber adjacent said first chamber, said second chamber forming a fluid-supply chamber or a fluid-discharge chamber through which the second fluid can flow;
a semi-permeable membrane disposed at least in parts of a boundary region between a volume of said first chamber and a volume of said second chamber, said semi-permeable membrane being an elastic membrane mounted on a supporting wall formed with a multiplicity of holes, wherein said membrane is impermeable to molecules or molecule agglomerations of the first fluid and permeable to molecules or molecule agglomerations of the second fluid.

42. The apparatus according to claim 41, wherein said semi-permeable membrane is a hydrophobic membrane.

43. The apparatus according to claim 41, wherein said semi-permeable membrane is an oleophobic membrane.

44. The apparatus according to claim 41, wherein said supporting wall is formed with holes selected from the group consisting of circular holes and slit-shaped holes.

45. The apparatus according to claim 41, wherein said first chamber bounds a contiguous and interlinked mixing-chamber volume, said second chamber is formed by a plurality of mutually separate sub-chambers each having a respective sub-volume of the fluid-supply chamber or fluid-discharge chamber, wherein said sub-chambers upstream of the apparatus open out into a fluid-supply collecting line and said sub-chambers downstream of the apparatus open out into a fluid-discharge collecting line.

46. The apparatus according to claim 45, wherein said sub-chambers of said second chamber are transverse channels extending transversely to the mixing-fluid-flow direction of said first chamber and channel walls of said sub-chambers have a supporting wall, formed with a multiplicity of holes, and an elastic membrane, mounted on the supporting wall, forming a semi-permeable membrane.

47. The apparatus according to claim 46, wherein said transverse channels are spaced-apart transverse channels with a circular or polygonal channel cross section.

48. The apparatus according to claim 46, wherein said transverse channels extend parallel to one another.

49. The apparatus according to claim 46, wherein said transverse channels include a first multiplicity of transverse channels with a first channel cross-sectional surface area and a second multiplicity of transverse channels with a second channel cross-sectional surface area.

50. The apparatus according to claim 49, wherein said transverse channels of said first multiplicity of transverse channels and of said second multiplicity of transverse channels are distributed uniformly in said first chamber.

51. The apparatus according to claim 50, wherein a ratio between a second channel cross-sectional surface area to a first channel cross-sectional surface area lies in the range from 1:10 to 5:10.

52. The apparatus according to claim 41, which further comprises a pressure source for generating a variable pressure in fluidic communication with said first chamber or with said second chamber.

53. The apparatus according to claim 46, wherein said transverse channels, in a region of their respective first ends, are fastened on a first carrier (e.g. first wall panel) and extend therethrough, and wherein said first carrier and said transverse channels together form a first subassembly of the apparatus.

54. The apparatus according to claim 53, wherein said transverse channels of the first subassembly, in a region of their respective second ends, extend through openings in a second carrier (e.g. second wall panel), and wherein said second carrier together with further walls of said first chamber form a second subassembly of the apparatus.

55. The apparatus according to claim 46, wherein said transverse channels form said static mixing elements of said first chamber.

56. A method for mixing and exchanging fluids, which comprises:
providing an apparatus according to claim 25; and
feeding a first fluid and a second fluid through the first chamber (mixing chamber) and feeding the second fluid through the second chamber.

57. The method according to claim 56 configured for introducing gas into a liquid, the method which comprises directing a liquid/gas mixture through the first chamber and directing the gas through the second chamber at a higher pressure than a pressure of the liquid/gas mixture in the first chamber.

58. The method according to claim 56 configured for removing gas from a liquid, the method which comprises directing a liquid/gas mixture through the first chamber and directing the gas through the second chamber at a lower pressure than a pressure of the liquid/gas mixture in the first chamber.

59. The method according to claim 56, which comprises, during an introduction or removal of gas, subjecting the pressure in the first chamber or the pressure in the second chamber to pulsation.

60. The method according to claim 56, which comprises providing the apparatus with a hydrophobic semipermeable membrane and providing the liquid with substances that are dissolved in water, emulsified in water or suspended in water.

61. The method according to claim 56, which comprises providing the apparatus with a hydrophilic semipermeable membrane and providing the liquid with substances that are dissolved in fat or oil, emulsified in fat or oil or suspended in fat or oil.

62. A method for mixing and exchanging fluids, which comprises:
providing an apparatus according to claim 46; and
feeding a first fluid and a second fluid through the first chamber (mixing chamber) and feeding the second fluid through the second chamber.
